(19) United States
(12) Patent Application Publication
(10) Pub. No.: US 2020/0034098 A1
(43) Pub. Date: Jan. 30, 2020

(54) CONTROL DEVICE AND COMPUTER-READABLE STORAGE MEDIUM

(71) Applicant: HONDA MOTOR CO.,LTD., Tokyo (JP)

(72) Inventors: Mutsumi KATAYAMA, Saitama (JP); Naohide AIZAWA, Tokyo (JP); Yuji NISHIKAWA, Saitama (JP)

(21) Appl. No.: 16/525,617

(22) Filed: Jul. 30, 2019

(30) Foreign Application Priority Data
Jul. 30, 2018 (JP) 2018-142745

(51) Int. Cl. G06F 3/14; H04W 76/10; G06F 3/0482; H04N 7/04; H04N 5/247; G01C 21/28; G01C 21/36

(52) U.S. Cl. CPC G06F 3/14; H04W 76/10; G06F 3/0482; H04N 7/04; G01C 21/3647; G01C 21/28; G01C 21/3644; G01C 21/367; H04N 5/247

(57) ABSTRACT

A control device is provided, the control device including: a target geographical point indication acquiring unit that acquires an indication of an image-capturing target geographical point; a candidate display control unit that causes an image-capturing direction candidate to be displayed, the image-capturing direction candidate being a candidate of a direction in which an image of the image-capturing target geographical point is to be captured; a selection indication receiving unit that receives an indication of selection of an image-capturing direction candidate; and a captured-image receiving unit that receives, from a device, a captured image capturing an image of the image-capturing target geographical point, the device being a device that has captured the image of the image-capturing target geographical point in a direction of the image-capturing direction candidate indicated by the indication of selection received by the selection indication receiving unit.

The contents of the following Japanese patent application are incorporated herein by reference: 2018-142745 filed in JP on Jul. 30, 2018

### BACKGROUND

### 1. Technical Field

The present invention relates to a control device, and a computer-readable storage medium.

### 2. Related Art

There are known in-vehicle systems having means for: receiving an indication of selection of a to-be-observed geographical point from a user; requesting a second in-vehicle system to capture an image of the to-be-observed geographical point; receiving an image of the to-be-observed geographical point from the second in-vehicle system; and displaying the received image (see Patent Literature 1, for example).

### PRIOR ART LITERATURE

### Patent Literature

[Patent Literature 1] Japanese Patent Application Publication No. 2006-031583

### SUMMARY

It is desirable to provide a technique that can reduce the burden on users in selecting image-capturing targets.

### BRIEF DESCRIPTION I/F THE DRAWINGS

FIG. 1 schematically illustrates an exemplary communication environment of vehicles 100.

FIG. 2 schematically illustrates an exemplary configuration of a vehicle 100.

FIG. 3 schematically illustrates an exemplary image-capturing direction candidate 312 and candidate 314 displayed for an image-capturing target geographical point 302.

FIG. 4 is an explanatory diagram for explaining a communication path of a captured image.

FIG. 5 schematically illustrates an exemplary functional configuration of a control device 200.

FIG. 6 schematically illustrates an exemplary flow of processes to be performed by the control device 200.

FIG. 7 schematically illustrates an exemplary flow of processes to be performed by the control device 200.

FIG. 8 schematically illustrates an exemplary flow of processes to be performed by the control device 200.

FIG. 9 schematically illustrates an exemplary flow of processes to be performed by the control device 200.

FIG. 10 schematically illustrates an exemplary hardware configuration of a computer 1000 to function as the control device 200.

FIG. 11 schematically illustrates an exemplary functional configuration of a communication terminal 500.

FIG. 12 schematically illustrates an exemplary hardware configuration of a computer 1100 to function as the communication terminal 500.

### DESCRIPTION I/F EXEMPLARY EMBODIMENTS

Hereinafter, (some) embodiment(s) of the present invention will be described. The embodiment(s) do(es) not limit the invention according to the claims, and all the combinations of the features described in the embodiment(s) are not necessarily essential to means provided by aspects of the invention.

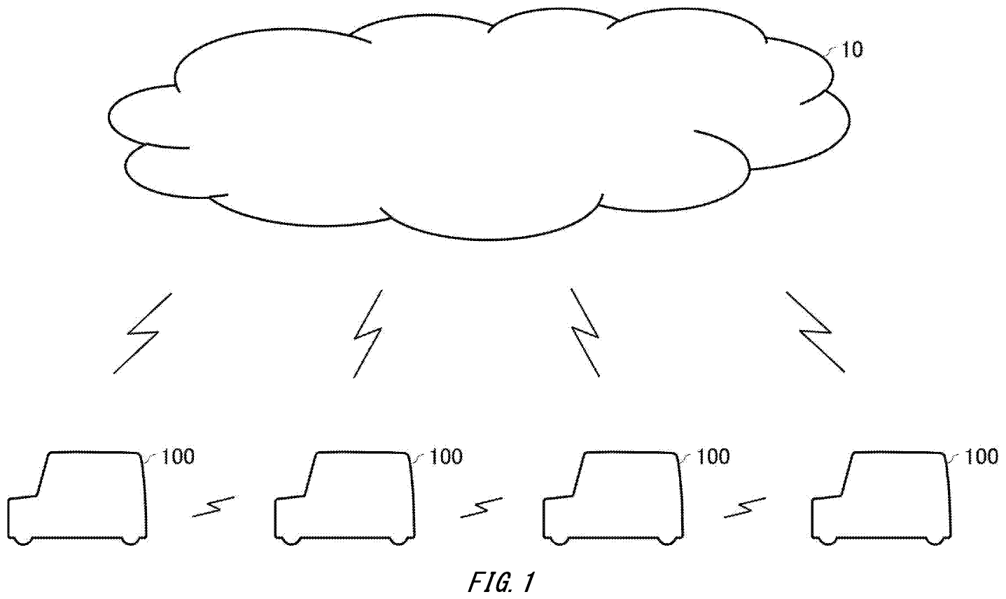

FIG. 1 schematically illustrates an exemplary communication environment of vehicles 100 according to the present embodiment. Each vehicle 100 wirelessly communicates with other vehicles 100. The vehicle 100 may wirelessly communicates with other vehicles 100 through at least any one of wireless communication with the other vehicles 100 over a network 10, direct wireless communication with the other vehicles 100 (which is referred to as vehicle-to-vehicle direct communication in some cases), and wireless communication with the other vehicles 100 through vehicle-to-infrastructure communication (which is referred to as vehicle-to-infrastructure communication).

The network 10 may be any network. For example, the network 10 may include at least any one of the internet, a mobile network such as a so-called 3G (3rd Generation) network, LTE (Long Term Evolution) network, 4G (4th Generation) network or 5G (5th Generation) network, a public wireless LAN (Local Area Network), and a leased network.

The vehicle 100 may use any known vehicle-to-vehicle communication technique or vehicle-to-infrastructure communication technique to execute vehicle-to-vehicle direct communication or vehicle-to-infrastructure communication. For example, the vehicle 100 executes vehicle-to-vehicle direct communication or vehicle-to-infrastructure communication through communication utilizing a predetermined frequency band such as the 700 MHz band or 5.8 GHz band. The vehicle 100 may wirelessly communicate with another vehicle 100 by way of still another vehicle 100. For example, an inter-vehicle network may be formed by a plurality of vehicles 100 jointly operating through vehicle-to-vehicle direct communication or vehicle-to-infrastructure communication, and remote vehicles 100 may execute communication with each other over the inter-vehicle network.

The vehicle 100 includes an image capturing unit that captures images of the space around the vehicle 100, and sends a captured image captured by the image capturing unit to a second vehicle 100, and receives a captured image captured by an image capturing unit of a second vehicle 100 from the second vehicle 100. The captured images may be still images or may be motion images (moving images).

For example, the vehicle 100 broadcasts, to other vehicles 100, request information including an image-capturing target geographical point selected by a user of the vehicle 100, and receives a captured image capturing an image of the image-capturing target geographical point from a second vehicle 100 that can capture an image of the image-capturing target geographical point. Thereby, the real-time situation of the image-capturing target geographical point can be informed to the user of the vehicle 100.

In addition, the vehicle 100 broadcasts, to other vehicles 100, request information including an image-capturing target geographical point, and an image-capturing direction in which an image of the image-capturing target geographical point is to be captured, and receives, from a second vehicle 100, a captured image capturing an image of the image-capturing target geographical point in the image-capturing direction from the second vehicle 100, the second vehicle 100 being a vehicle that can capture an image of the image-capturing target geographical point in the image-capturing direction. Thereby, the situation of the image-capturing target geographical point as seen from a particular direction can be informed to the user of the vehicle 100.

Here, if there is not a vehicle that can capture an image of an image-capturing target geographical point in an image-capturing direction although the user of the vehicle 100 selected the image-capturing target geographical point and the image-capturing direction, this results in the user being unable to view a captured image although he/she selected the image-capturing target geographical point and the image-capturing direction. It is desirable to provide a technique that can lower the possibility of occurrence of such an event.

If the vehicle 100 according to the present embodiment received an indication of selection of an image-capturing target geographical point, the vehicle 100 displays an image-capturing direction candidate in which an image of the image-capturing target geographical point is to be captured, and receives an indication of candidate selection to thereby select an image-capturing direction. The vehicle 100 displays, as a candidate, an image-capturing direction in which a vehicle that already captured an image of the image-capturing target geographical point captured the image of the image-capturing target geographical point at a time point when the vehicle 100 received an indication of selection of the image-capturing target geographical point, for example. Thereby, it is possible to reduce occurrence of events where a user is unable to view a captured image of an image-capturing target geographical point captured in an image-capturing direction although he/she selected the image-capturing target geographical point and the image-capturing direction. In addition, after receiving an indication of selection of an image-capturing target geographical point, the vehicle 100 identifies a direction in which a second vehicle can capture an image of the image-capturing target geographical point, and displays the identified direction as a candidate. Thereby, it is possible to lower the possibility of occurrence of events where a user is unable to view a captured image of an image-capturing target geographical point captured in an image-capturing direction although he/she selected the image-capturing target geographical point and the image-capturing direction.

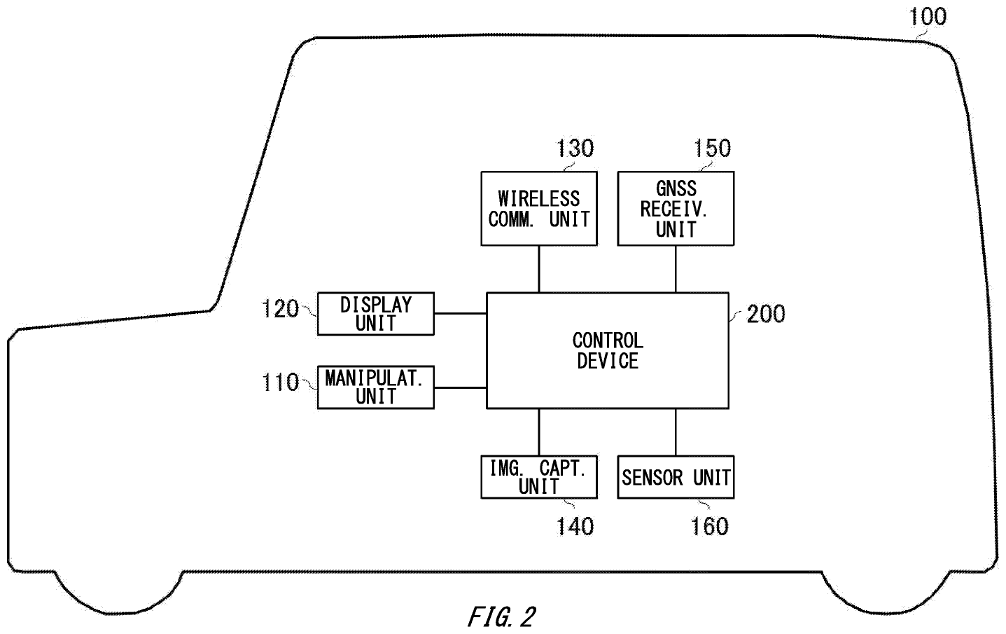

FIG. 2 schematically illustrates an exemplary configuration of a vehicle 100. The vehicle 100 includes a manipulating unit 110, a display unit 120, a wireless communication unit 130, an image capturing unit 140, a GNSS (Global Navigation Satellite System) receiving unit 150, a sensor unit 160, and a control device 200. At least some of these configurations may be configurations included in a so-called car navigation system.

The manipulating unit 110 undergoes manipulation by a user of the vehicle 100. The manipulating unit 110 may include physical manipulation buttons, and the like. The manipulating unit 110 and display unit 120 may be a touch panel display. The manipulating unit 110 may undergo audio manipulation. The manipulating unit 110 may include a microphone, and a speaker.

The wireless communication unit 130 executes wireless communication with other vehicles 100. The wireless communication unit 130 may include a communication unit that communicates with the network 10 via radio base stations in a mobile network. In addition, the wireless communication unit 130 may include a communication unit that communicates with the network 10 via WiFi (registered trademark) access points. In addition, the wireless communication unit 130 may include a communication unit that executes vehicle-to-vehicle communication. In addition, the wireless communication unit 130 may include a communication unit that executes vehicle-to-infrastructure communication.

The image capturing unit 140 includes one or more cameras. The cameras may be a drive recorder. If the image capturing unit 140 includes a plurality of cameras, the plurality of cameras are placed at different positions in the vehicle 100. In addition, the plurality of cameras capture images in different image-capturing directions.

The GNSS receiving unit 150 receives radio waves emitted from a GNSS satellite. The GNSS receiving unit 150 may identify the position of the vehicle 100 based on signals received from the GNSS satellite.

The sensor unit 160 includes one or more sensors. The sensor unit 160 includes an acceleration sensor, for example. The sensor unit 160 includes an angular velocity sensor (gyro sensor), for example. The sensor unit 160 includes a geomagnetic sensor, for example. The sensor unit 160 includes a vehicle speed sensor, for example.

The control device 200 controls the manipulating unit 110, display unit 120, wireless communication unit 130, image capturing unit 140, GNSS receiving unit 150, and sensor unit 160, and executes various types of processing. The control device 200 executes a navigation process, for example. The control device 200 may execute a navigation process similar to a navigation process executed by known car navigation systems.

For example, the control device 100 identifies the current position of the vehicle 200 based on output from the GNSS receiving unit 150, and sensor unit 160, reads out map data corresponding to the current position, and makes the display unit 120 display the map data. In addition, a destination is input to the control device 200 via the manipulating unit 110, and the control device 200 identifies recommended routes from the current position of the vehicle 100 to the destination, and makes the display unit 120 display the recommended routes. If the control device 200 received an indication of selection of a route, the control device 200 gives directions about a course along which the vehicle 100 should travel, via the display unit 120 and a speaker according to the selected route.

The control device 200 according to the present embodiment executes a process of causing an image-capturing direction candidate to be displayed, the image-capturing direction candidate being a direction in which an image of an image-capturing target geographical point is to be captured, and a process of receiving an indication of candidate selection by a user. For example, the control device 200 first receives, via the manipulating unit 110, an indication of selection of an image-capturing target geographical point by a user. The control device 200 receives an indication of pointing input on a map displayed on the display unit 120, for example. In addition, the control device 200 receives an indication of audio input to select an image-capturing target geographical point, for example.

Then, the control device 200 broadcasts positional information indicating the image-capturing target geographical point toward other vehicles 100 via at least any one of the network 10 and an inter-vehicle network. The control device 200 receives, from a vehicle 100, an indication of an image-capturing direction in which an image of the image-capturing target geographical point is captured, the vehicle 100 being a vehicle that received the positional information, and already captured the image of the image-capturing target geographical point, for example, and the control devices 200 makes the display unit 120 display the image-capturing direction as a candidate. Along with the positional information, the control device 200 may send a condition for determining whether or not an image of the image-capturing target geographical point has already been captured. For example, along with the positional information, the control device 200 sends a condition based on which a judgement is made that an image of the image-capturing target geographical point has already been captured if an image of the image-capturing target geographical point has been captured in a time period from a first time point at which the positional information was received to a second time point which is a predetermined length of time before the first time point.

In addition, for example, the control device 200 first broadcasts positional information indicating the image-capturing target geographical point toward other vehicles 100 via at least any one of the network 10 and an inter-vehicle network. Then, the control device 200 receives, from a vehicle 100, an indication of an image-capturing direction in which an image of the image-capturing target geographical point is to be captured, the vehicle 100 being a vehicle that received the positional information, and is to capture an image of the image-capturing target geographical point after receiving the positional information, and the control device 200 makes the display unit 120 display the image-capturing direction as a candidate. A vehicle 100 that received the positional information, for example, refers to a route to a destination of the vehicle 100. If the image-capturing target geographical point is included in the route, the vehicle 100 sends, to the vehicle 100 that sent the positional information, an image-capturing direction in which an image of the image-capturing target geographical point can be captured in the route.

In addition, for example, if the control device 200 can be informed of the positions of other vehicles 100, the control device 200 identifies a vehicle 100 that can capture an image of the image-capturing target geographical point among a plurality of vehicles 100, and makes the display unit 120 display, as a candidate, an image-capturing direction in which the identified vehicle 100 is to captured an image of the image-capturing target geographical point. The control device 200 receives vehicle information including the positions of other vehicles 100 that those vehicles 100 send regularly, for example, to thereby be able to be informed of the positions of the vehicles 100. The vehicle information may include information other than the position of a vehicle 100. For example, the vehicle information includes the travelling situation of a vehicle 100. The vehicle information includes the advancing direction, travelling speed, and the like of a vehicle 100, for example. In addition, the vehicle information includes route information indicating a route to a destination of a vehicle 100, for example. The control device 200 may receive, via at least any one of the network 10 and an inter-vehicle network, vehicle information that other vehicles 100 send regularly. In addition, the control device 200 may receive vehicle information about other vehicles 100 from a vehicle managing device that receives, via at least any one of the network 10 and an inter-vehicle network, vehicle information that those vehicles 100 send regularly, and manages the vehicle information.

The control device 200 may receive, via the manipulating unit 110, an indication of selection of an image-capturing direction candidate that the control device 200 caused the display unit 120 to display. The control device 200 receives an indication of pointing input on an image-capturing direction candidate displayed on the display unit 120, for example. In addition, the control device 200 receives an indication of audio input indicating any one of image-capturing directions. In a specific exemplary case, the control device 200 causes candidate image-capturing directions to be displayed along with numbers allocated to them, and receives an indication of audio input about a number.

If the control device 200 received an indication of selection of an image-capturing direction candidate, the control device 200 executes a display process of receiving, from a vehicle, a captured image capturing an image of an image-capturing target geographical point, the vehicle being a vehicle that captured the image of the image-capturing target geographical point in the image-capturing direction, and of causing the captured image to be displayed.

The control device 200, for example, sends request information for requesting a vehicle 100 that already captured an image of an image-capturing target geographical point in a selected image-capturing direction to send the captured image, and receives the captured image sent by the vehicle 100 in response to the request information. Communication between the control device 200 and the outside of the vehicle 100 may be performed via the wireless communication unit 130.

In addition, the control device 200, for example, sends request information for requesting a vehicle 100 that is to capture an image of an image-capturing target geographical point in a selected image-capturing direction to send the captured image of the image-capturing target geographical point, and establishes a connection for receiving the captured image from the vehicle 100 if a positive acknowledgement to the request information is received. Then, the control device 200 receives the captured image via the established connection after the vehicle 100 starts capturing the image of the image-capturing target geographical point. The control device 200 may make the display unit 120 display the received captured image.

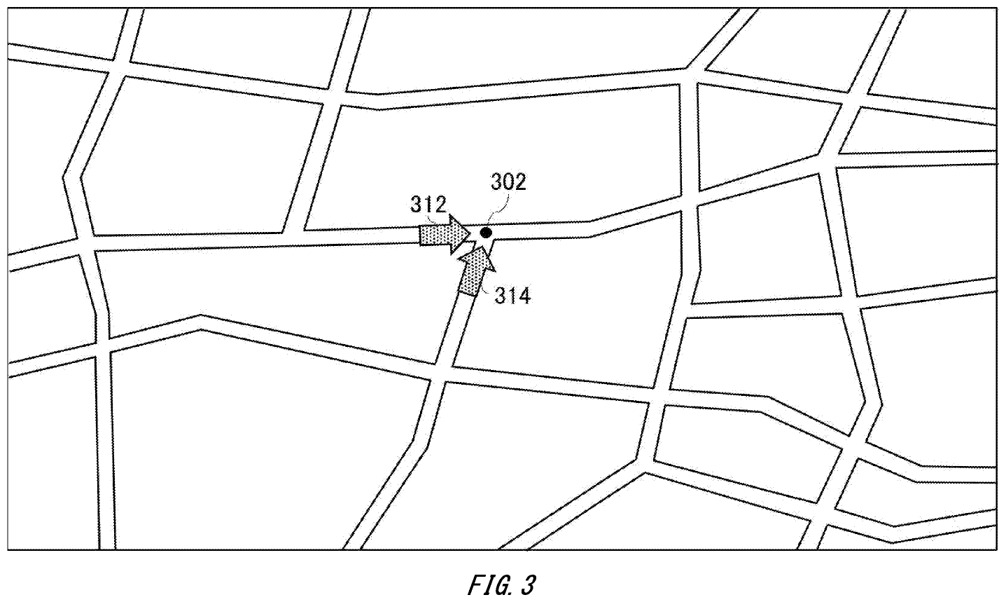

FIG. 3 schematically illustrates an exemplary image-capturing direction candidate 312 and candidate 314 displayed for an image-capturing target geographical point 302. Although FIG. 3 illustrates an example where two candidates, the candidate 312 and candidate 314, are displayed, the number of candidates may be one, or three or larger.

A user may select the candidate 312 or candidate 314 displayed as in the example illustrated in FIG. 3. The user selects the candidate 312 or candidate 314 by touch input, for example. In addition, for example, the control device 200 may cause certain characters, numbers, symbols or the like, such as A for the candidate 312 and B for the candidate 314, that identify the candidate 312 and the candidate 314 to be displayed in association with the candidate 312 and the candidate 314, and the user may select a candidate by inputting audio information indicating any one of these characters, numbers, symbols, or the like.

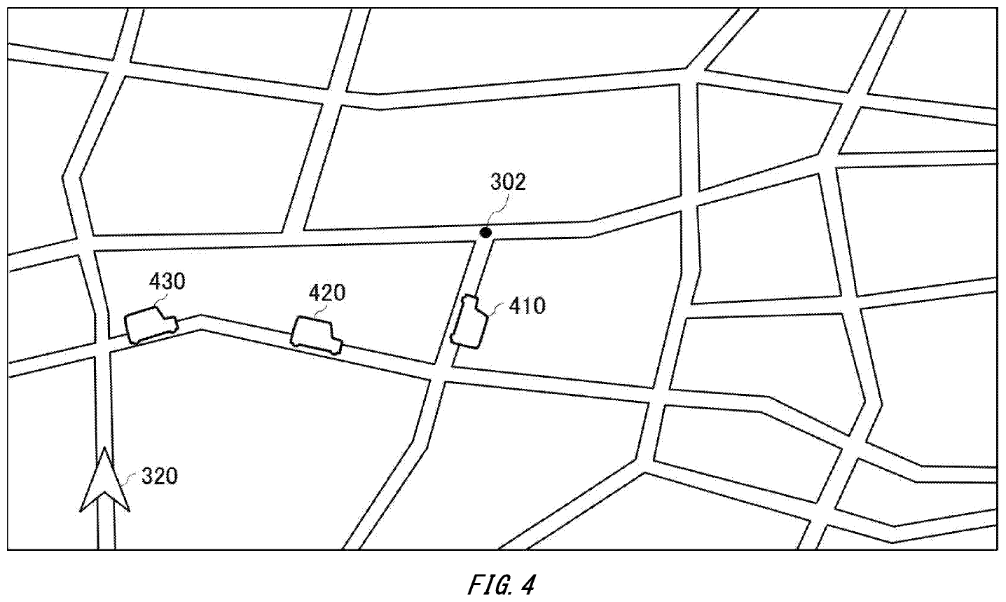

FIG. 4 is an explanatory diagram for explaining a communication path of a captured image. In an example explained with reference to FIG. 4, a vehicle 410 sends, to a vehicle 100 positioned at a current position 320, a captured image captured while the vehicle 410 is heading to the image-capturing target geographical point 302. The vehicle 410, a vehicle 420, and a vehicle 430 illustrated in FIG. 4 may have configurations similar to that of the vehicle 100.

If the vehicle 100 is positioned within the communication range of vehicle-to-vehicle direct communication, the vehicle 410 may send a captured image to the vehicle 100 via vehicle-to-vehicle direct communication. In addition, even if the vehicle 100 is positioned within the communication range of vehicle-to-vehicle direct communication, the vehicle 410 may send a captured image to the vehicle 100 via the network 10. In addition, the vehicle 410 may send a captured image to the vehicle 100 by way of the vehicle 420 and the vehicle 430. If the vehicle 100 is not positioned within the communication range of vehicle-to-vehicle direct communication, the vehicle 410 may send a captured image to the vehicle 100 via the network 10. In addition, the vehicle 410 may send a captured image to the vehicle 100 by way of the vehicle 420 and the vehicle 430.

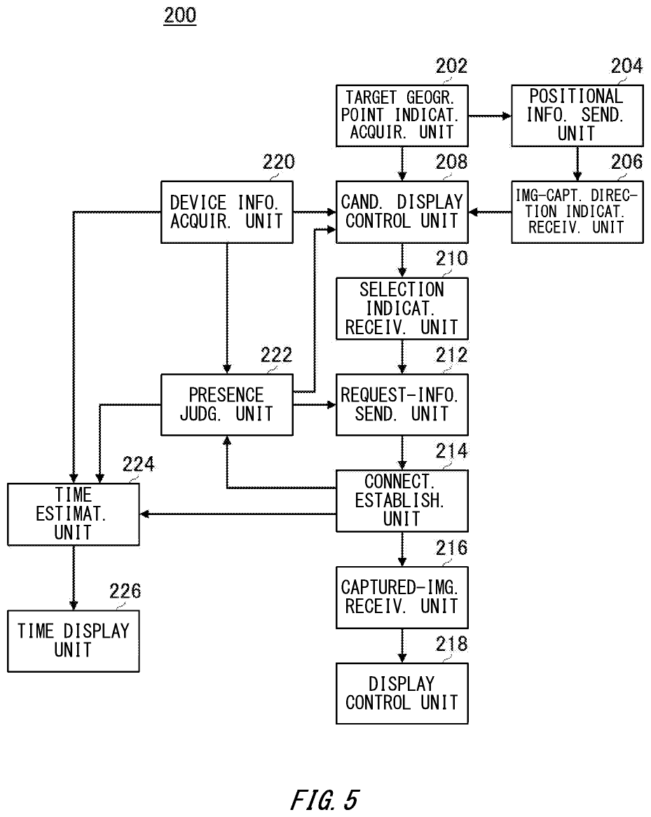

FIG. 5 schematically illustrates an exemplary functional configuration of the control device 200. The control device 200 includes a target geographical point indication acquiring unit 202, a positional information sending unit 204, an image-capturing direction indication receiving unit 206, a candidate display control unit 208, a selection indication receiving unit 210, a request-information sending unit 212, a connection establishing unit 214, a captured-image receiving unit 216, a display control unit 218, a device information acquiring unit 220, a presence judging unit 222, a time estimating unit 224, and a time display unit 226. Note that the control device 200 is not necessarily required to include all of these configurations.

The target geographical point indication acquiring unit 202 acquires an indication of an image-capturing target geographical point. The target geographical point indication acquiring unit 202 acquires an indication of an image-capturing target geographical point that the manipulating unit 110 receives as an indication of selection through pointing input, for example. In addition, the target geographical point indication acquiring unit 202 acquires an indication of an image-capturing target geographical point that the manipulating unit 110 receives as an indication of selection through audio input.

The positional information sending unit 204 broadcasts, to other devices, positional information indicating the image-capturing target geographical point indicated by the indication acquired by the target geographical point indication acquiring unit 202. Examples of such other devices include other vehicles 100. In addition, examples of such other devices include devices mounted on other vehicles 100. The positional information sending unit 204 may broadcast, to other devices, positional information via at least any one of the network 10 and an inter-vehicle network.

The image-capturing direction indication receiving unit 206 receives an indication of an image-capturing direction. The image-capturing direction indication receiving unit 206 receives, from a device, an indication of an image-capturing direction in which an image of the image-capturing target geographical point has been captured, the device being a device that received the positional information sent by the positional information sending unit 204, and already captured an image of the image-capturing target geographical point, for example. In addition, for example, the image-capturing direction indication receiving unit 206 receives, from a device, an indication of an image-capturing direction in which an image of the image-capturing target geographical point is to be captured, the device being a device that received the positional information, and is to capture an image of the image-capturing target geographical point after receiving the positional information.

Along with an indication of an image-capturing direction, the image-capturing direction indication receiving unit 206 may receive identification information indicating a device that sent the indication of the image-capturing direction. The identification information may be information that can identify the device in communication. For example, the identification information is an ID, an IP address, or the like allocated to the device.

The candidate display control unit 208 causes an image-capturing direction candidate to be displayed. The candidate display control unit 208 causes an image-capturing direction indicated by an indication received by the image-capturing direction indication receiving unit 206 to be displayed as an image-capturing direction candidate, for example. The candidate display control unit 208 may make the display unit 120 display an image-capturing direction candidate.

In addition, the candidate display control unit 208 may cause an image-capturing direction candidate to be displayed based on a direction of a neighboring road of an image-capturing target geographical point indicated by an indication acquired by the target geographical point indication acquiring unit 202. For example, the candidate display control unit 208 treats, as an image-capturing direction candidate, a direction of a road positioned within a predetermined range from an image-capturing target geographical point indicated by an indication acquired by the target geographical point indication acquiring unit 202. The predetermined range may be arbitrarily selected, and may be changeable. For example, if a neighboring road of an image-capturing target geographical point is an unbranched road, the candidate display control unit 208 treats, as image-capturing direction candidates, a first direction along the direction of the road, and a second direction opposite to the first direction. If the road is a one-way road, the advancing direction of the one-way road may be the only image-capturing direction candidate. In addition, for example, if a neighboring road of an image-capturing target geographical point is an intersection, the candidate display control unit 208 may treat the direction of the road relative to the intersection as an image-capturing direction candidate.

The selection indication receiving unit 210 receives an indication of selection of an image-capturing direction candidate. The selection indication receiving unit 210 may receive an indication of selection of an image-capturing direction candidate displayed on the display unit 120 under control of the candidate display control unit 208. The selection indication receiving unit 210 may receive an indication of selection of an image-capturing direction candidate via the manipulating unit 110. The selection indication receiving unit 210 receives an indication of selection of an image-capturing direction candidate made through at least any one of pointing input and audio input, for example.

The request-information sending unit 212 sends request information for requesting a device to send a captured image of an image-capturing target geographical point, the device being a device that captured an image of or a device that is to capture an image of the image-capturing target geographical point in the direction of the image-capturing direction candidate indicated by an indication of selection received by the selection indication receiving unit 210. If a positive acknowledgement to the request information sent by the request-information sending unit 212 is received, the connection establishing unit 214 establishes a connection for communication of the captured image with the device that sent the positive acknowledgement.

The captured-image receiving unit 216 receives the captured image from the device via the connection established by the connection establishing unit 214. The display control unit 218 causes the captured image received by the captured-image receiving unit 216 to be displayed. The display control unit 218 makes the display unit 120 display the captured image, for example. In addition, the display control unit 218 may send the captured image to a preselected communication terminal, and cause the communication terminal to display the captured image. Exemplary communication terminals include a mobile phone such as a smartphone, a tablet terminal and the like owned by a user of the vehicle 100.

The device information acquiring unit 220 acquires device information including the position of a device. The device is the vehicle 100, for example, as mentioned above. The vehicle information mentioned above may be exemplary device information. The device information acquiring unit 220 may acquire device information stored in the control device 200. The control device 200 may receive and store device information sent regularly by a device. In addition, the control device 200 receives device information regularly via the network 10 from a managing device that manages device information about a plurality of devices, and the control device 200 stores the received device information. The control device 200 receives and stores vehicle information sent regularly by a second vehicle 100 via at least any one of the network 10 and an inter-vehicle network, for example. In addition, the control device 200 receives vehicle information regularly via the network 10 from a vehicle managing device that manages vehicle information about a plurality of vehicles 100, and the control device 200 stores the received device information.

Based on device information acquired by the device information acquiring unit 220, the candidate display control unit 208 may identify a direction in which another device can capture an image of an image-capturing target geographical point, and cause the identified direction to be displayed as an image-capturing direction candidate. The candidate display control unit 208 uses the position of another device and its advancing direction to identify a direction in which the device can capture an image of an image-capturing target geographical point, for example. In addition, the candidate display control unit 208 uses the position of another device and its route information to identify a direction in which the device can capture an image of an image-capturing target geographical point, for example.

Before a moving body as a device that has established a connection with the connection establishing unit 214, and is sending captured images while on the move passes through an image-capturing target geographical point, the presence judging unit 222 may judge, based on device information, whether or not there is another device that can capture an image of the image-capturing target geographical point in an image-capturing direction indicated by an indication of selection received by the selection indication receiving unit 210. If the presence judging unit 222 judges that there is such a device, the request-information sending unit 212 may send request information for requesting the device to send a captured image of the image-capturing target geographical point. Thereby, even after a device with which a connection has been established passed through the image-capturing target geographical point, a captured image of the image-capturing target geographical point captured in the selected image-capturing direction can be received.

If the presence judging unit 222 judges that there is not such a device, the candidate display control unit 208 identifies a direction in which another device can capture an image of the image-capturing target geographical point at the time of the judgement, and causes the identified image-capturing direction to be displayed as an image-capturing direction candidate. Thereby, even after a device with which a connection has been established passed through the image-capturing target geographical point, a captured image of the image-capturing target geographical point can be received, although the captured image is captured from a different image-capturing direction.

Before a moving body as a device that has established a connection with the connection establishing unit 214 captures an image of an image-capturing target geographical point, the presence judging unit 222 may judge, based on device information, whether or not there is another device that can capture an image of the image-capturing target geographical point in an image-capturing direction indicated by an indication of selection received by the selection indication receiving unit 210. If the presence judging unit 222 judges that there is such a device, the request-information sending unit 212 may send request information for requesting the device to send a captured image of the image-capturing target geographical point. If the presence judging unit 222 judges that there is not such a device, the candidate display control unit 208 may cause an image-capturing direction candidate to be displayed. For example, if there is another device that can capture an image of an image-capturing target geographical point in an image-capturing direction other than an image-capturing direction indicated by an indication of selection received by the selection indication receiving unit 210, the image-capturing direction in which the device can capture an image of the image-capturing target geographical point is displayed as a candidate. Thereby, for example, if, although the connection establishing unit 214 has established a connection with a device, it inevitably takes a long time for the device to start image-capturing, a different image-capturing direction can be proposed.

The time estimating unit 224 estimates a length of time required for a moving body as a device that has established a connection with the connection establishing unit 214 to capture an image of the image-capturing target geographical point. The time estimating unit 224 uses the position of the moving body and the position of the image-capturing target geographical point to estimate the length of time, for example. The time estimating unit 224 may estimate the length of time based further on the moving speed of the moving body. For example, if the moving body is a vehicle 100, the time estimating unit 224 estimates the length of time based further on the travelling speed of the vehicle 100. In addition, the time estimating unit 224 may estimate the length of time based further on traffic information about a route from the moving body to the image-capturing target geographical point.

The time display unit 226 causes the length of time estimated by the time estimating unit 224 to be displayed. Depending on a result of judgement by the presence judging unit 222, the time display unit 226 may cause the length of time estimated by the time estimating unit 224 to be displayed. For example, if the presence judging unit 222 judges that there is not another device that can capture an image of an image-capturing target geographical point in an image-capturing direction indicated by an indication of selection received by the selection indication receiving unit 210 before a moving body as a device that has established a connection with the connection establishing unit 214 captures an image of the image-capturing target geographical point, the time display unit 226 may cause the length of time estimated by the time estimating unit 224 to be displayed. The time display unit 226 makes the display unit 120 display the length of time, for example. In addition, the time display unit 226 may send an indication of the length of time to a preselected communication terminal, and cause the communication terminal to display the length of time.

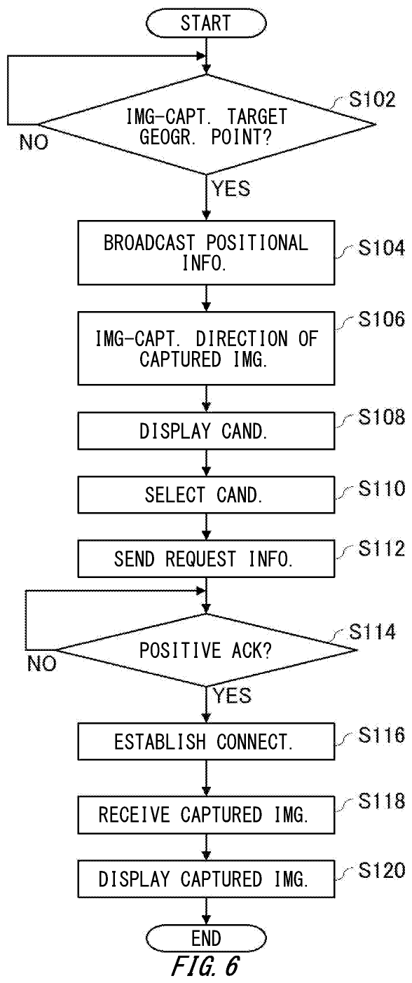

FIG. 6 schematically illustrates an exemplary flow of processes to be performed by the control device 200. FIG. 6 illustrates exemplary processes to be performed after an indication of selection of an image-capturing target geographical point is received until captured images captured by a vehicle 100 as an exemplary device is displayed. Each process illustrated in FIG. 6 may be executed under control of a control unit provided to the control device 200.

At Step (steps are abbreviated to S's in some cases) 102, if the manipulating unit 110 receives an indication of selection of an image-capturing target geographical point, the target geographical point indication acquiring unit 202 acquires an indication of the selected image-capturing target geographical point. At S104, the positional information sending unit 204 broadcasts positional information indicating the image-capturing target geographical point indicated by the indication acquired by the target geographical point indication acquiring unit 202 at S102.

At S106, an indication of an image-capturing direction in which an image of the image-capturing target geographical point is captured is received from a vehicle 100, the vehicle 100 being a vehicle that received the positional information, and already captured the image of the image-capturing target geographical point. At S108, as an image-capturing direction candidate, the candidate display control unit 208 makes the display unit 120 display the image-capturing direction indicated by the indication received at S106.

At S110, the selection indication receiving unit 210 receives an indication of selection of an image-capturing direction candidate. At S112, the request-information sending unit 212 sends request information for requesting a vehicle to send a captured image of the image-capturing target geographical point, the vehicle being a vehicle that captured an image of the image-capturing target geographical point in the image-capturing direction indicated by the indication of selection received at S110.

At S114, a positive acknowledgement is waited for. If a positive acknowledgement is received (YES at S114), the connection establishing unit 214 establishes a connection with a vehicle 100 that sent the positive acknowledgement (S116). If the control device 200 does not receive a positive acknowledgement until a predetermined length of time elapses, the control device 200 may end the processes. At S118, the captured-image receiving unit 216 receives a captured image. At S120, the display control unit 218 makes the display unit 120 display the captured image received at S118. Then, the processes end.

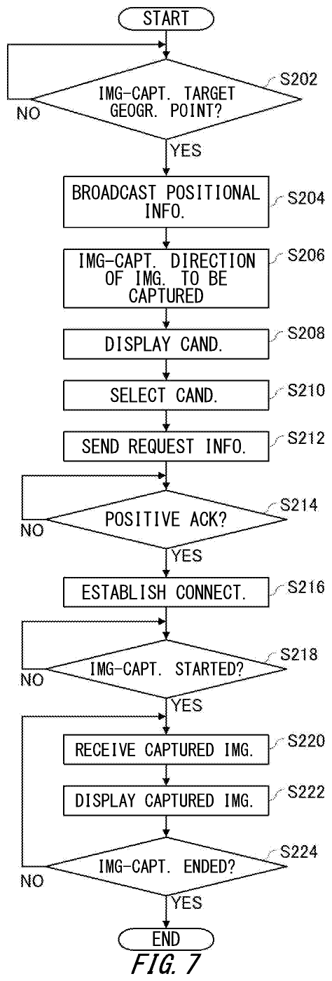

FIG. 7 schematically illustrates an exemplary flow of processes to be performed by the control device 200. FIG. 7 illustrates exemplary processes to be performed after an indication of selection of an image-capturing target geographical point is received until captured images captured by a vehicle 100 as an exemplary device is displayed. Here, differences from FIG. 6 are mainly explained.

At S202, if the manipulating unit 110 receives an indication of selection of an image-capturing target geographical point, the target geographical point indication acquiring unit 202 acquires an indication of the selected image-capturing target geographical point. At S204, the positional information sending unit 204 broadcasts positional information indicating the image-capturing target geographical point indicated by the indication acquired by the target geographical point indication acquiring unit 202 at S202.

At S206, an indication of an image-capturing direction in which an image of the image-capturing target geographical point is captured is received from a vehicle 100, the vehicle 100 being a vehicle that received the positional information, and is to capture an image of the image-capturing target geographical point after receiving the positional information. At S208, the candidate display control unit 208 causes the image-capturing direction indicated by the indication received at S206 to be displayed as an image-capturing direction candidate.

At S210, the selection indication receiving unit 210 receives an indication of selection of an image-capturing direction candidate. At S212, the request-information sending unit 212 sends request information for requesting a vehicle to send a captured image of the image-capturing target geographical point, the vehicle being a vehicle that captured an image of the image-capturing target geographical point in the image-capturing direction indicated by the indication of selection received at S210.

At S214, a positive acknowledgement is waited for. If a positive acknowledgement is received (YES at S214), the connection establishing unit 214 establishes a connection with a vehicle 100 that sent the positive acknowledgement (S216). At S218, start of image-capturing of the image-capturing target geographical point by the second vehicle 100 is waited for. When starting image-capturing of the image-capturing target geographical point, the second vehicle 100 may inform the control device 200 of that effect. If the image-capturing is started (YES at S218), the process proceeds to S220.

At S220, the captured-image receiving unit 216 receives captured images captured by the second vehicle 100 on its way toward the image-capturing target geographical point. At S222, the display control unit 218 makes the display unit 120 display the captured images. At S224, it is judged whether or not the image-capturing of the image-capturing target geographical point by the second vehicle 100 has ended. If the second vehicle 100 passed through the image-capturing target geographical point, for example, the second vehicle 100 informs the vehicle 100 that the image-capturing of the image-capturing target geographical point has ended.

If it is judged at S224 that the image-capturing has not ended, the process returns to S220, and reception and display of captured images are executed. If it is judged at S224 that the image-capturing has ended, the process ends.

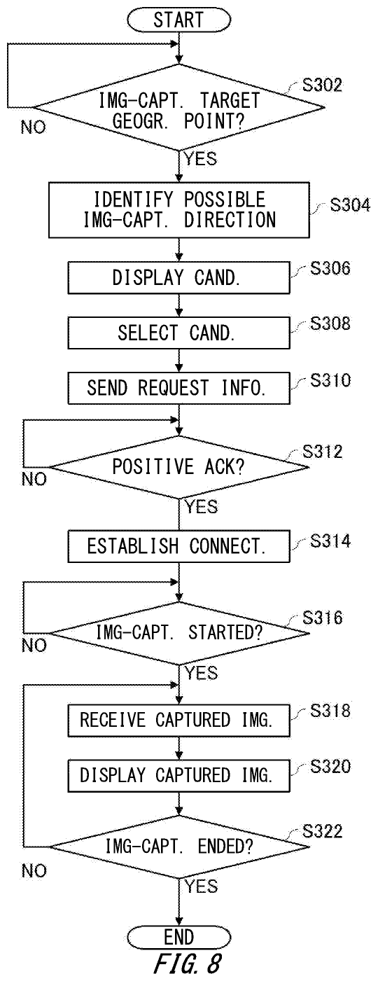

FIG. 8 schematically illustrates an exemplary flow of processes to be performed by the control device 200. FIG. 8 illustrates other exemplary processes to be performed after an indication of selection of an image-capturing target geographical point is received until captured images captured by a vehicle 100 as an exemplary device is displayed. Here, differences from FIG. 7 are mainly explained.

At S302, if the manipulating unit 110 receives an indication of selection of an image-capturing target geographical point, the target geographical point indication acquiring unit 202 acquires an indication of the selected image-capturing target geographical point. At S304, based on vehicle information acquired by the device information acquiring unit 220, the candidate display control unit 208 identifies a direction in which a second vehicle 100 can capture an image of the image-capturing target geographical point indicated by the indication acquired at S302.

At S306, as an image-capturing direction candidate, the candidate display control unit 208 makes the display unit 120 display the direction identified at S304. At S308, the selection indication receiving unit 210 receives an indication of selection of an image-capturing direction candidate. At S310, the request-information sending unit 212 sends request information for requesting a vehicle to send a captured image of the image-capturing target geographical point, the vehicle 100 being a vehicle that can capture an image of the image-capturing target geographical point in the direction of the image-capturing direction candidate indicated by the indication of selection received at S308.

At S312, a positive acknowledgement is waited for. If a positive acknowledgement is received (YES at S312), the connection establishing unit 214 establishes a connection with a vehicle 100 that sent the positive acknowledgement (S314). At S316, start of image-capturing of the image-capturing target geographical point by the vehicle 100 is waited for. When starting image-capturing of the image-capturing target geographical point, the vehicle 100 may inform the control device 200 of that effect. If the image-capturing is started (YES at S316), the process proceeds to S318.

At S318, the captured-image receiving unit 216 receives captured images captured by the vehicle 100 on its way toward the image-capturing target geographical point. At S320, the display control unit 218 makes the display unit 120 display the captured images. At S322, it is judged whether or not the image-capturing of the image-capturing target geographical point by the vehicle 100 has ended.

If it is judged at S322 that the image-capturing has not ended, the process returns to S318, and reception and display of captured images are executed. If it is judged at S322 that the image-capturing has ended, the process ends.

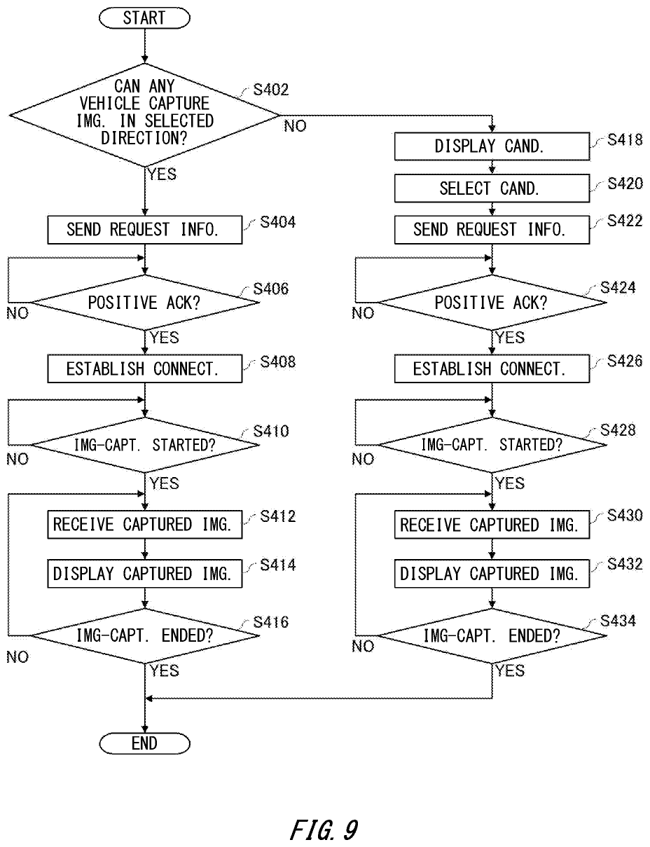

FIG. 9 schematically illustrates an exemplary flow of processes to be performed by the control device 200. FIG. 9 illustrates exemplary processes to be executed by the control device 200 while captured images are being displayed at S318, S320, and S322 in the flow illustrated in FIG. 8. Each process illustrated in FIG. 9 may be executed under control of a control unit of the control device 200.

At S402, the presence judging unit 222 judges whether or not there is a vehicle that can capture an image of an image-capturing target geographical point in the image-capturing direction selected at S308. If it is judged that there is such a vehicle, the process proceeds to S404, and if it is judged that there is not such a vehicle, the process proceeds to S418.

At S404, the request-information sending unit 212 sends request information for requesting a vehicle 100 to send a captured image of the image-capturing target geographical point, the vehicle 100 being a vehicle that can capture an image of the image-capturing target geographical point in the image-capturing direction.

At S406, a positive acknowledgement is waited for. If a positive acknowledgement is received (YES at S406), the connection establishing unit 214 establishes a connection with a vehicle 100 that sent the positive acknowledgement (S408). At S410, start of image-capturing of the image-capturing target geographical point by the vehicle 100 is waited for. When starting image-capturing of the image-capturing target geographical point, the vehicle 100 may inform the control device 200 of that effect. If the image-capturing is started (YES at S410), the process proceeds to S412.

At S412, the captured-image receiving unit 216 receives captured images captured by the vehicle 100 on its way toward the image-capturing target geographical point. At S414, the display control unit 218 makes the display unit 120 display the captured images. If the display of captured images at S318, S320, and S322 is still going on, at the same time while the captured images are being displayed, the display control unit 218 may cause the captured images received at S412 to displayed. In addition, the display control unit 218 may stop the display of captured images at S318, S320, and S322, and display captured images received at S412. At S416, it is judged whether or not the image-capturing of the image-capturing target geographical point by the vehicle 100 has ended.

If it is judged at S416 that the image-capturing has not ended, the process returns to S412, and reception and display of captured images are executed. If it is judged at S416 that the image-capturing has ended, the process ends.

At S418, based on vehicle information, the candidate display control unit 208 identifies a direction in which a second vehicle 100 can capture an image of the image-capturing target geographical point at the time of the judgement at S402, and causes the identified image-capturing direction to be displayed as an image-capturing direction candidate. At S420, the selection indication receiving unit 210 receives an indication of selection of an image-capturing direction candidate. At S422, the request-information sending unit 212 sends request information for requesting a vehicle to send a captured image of the image-capturing target geographical point, the vehicle being a vehicle that can capture an image of the image-capturing target geographical point in the direction of the image-capturing direction candidate indicated by the indication of selection received at S420.

At S424, a positive acknowledgement is waited for. If a positive acknowledgement is received (YES at S424), the connection establishing unit 214 establishes a connection with a vehicle 100 that sent the positive acknowledgement (S426). At S428, start of image-capturing of the image-capturing target geographical point by the vehicle 100 is waited for. When starting image-capturing of the image-capturing target geographical point, the vehicle 100 may inform the control device 200 of that effect. If the image-capturing is started (YES at S428), the process proceeds to S430.

At S430, the captured-image receiving unit 216 receives captured images captured by the vehicle 100 on its way toward the image-capturing target geographical point. At S432, the display control unit 218 makes the display unit 120 display the captured images. If the display of captured images at S318, S320, and S322 is still going on, at the same time while the captured images are being displayed, the display control unit 218 may cause the captured images received at S412 to be displayed. In addition, the display control unit 218 may stop the display of captured images at S318, S320, and S322, and display captured images received at S430. At S434, it is judged whether or not the image-capturing of the image-capturing target geographical point by the vehicle 100 has ended.

If it is judged at S434 that the image-capturing has not ended, the process returns to S430, and reception and display of captured images are executed. If it is judged at S434 that the image-capturing has ended, the process ends.

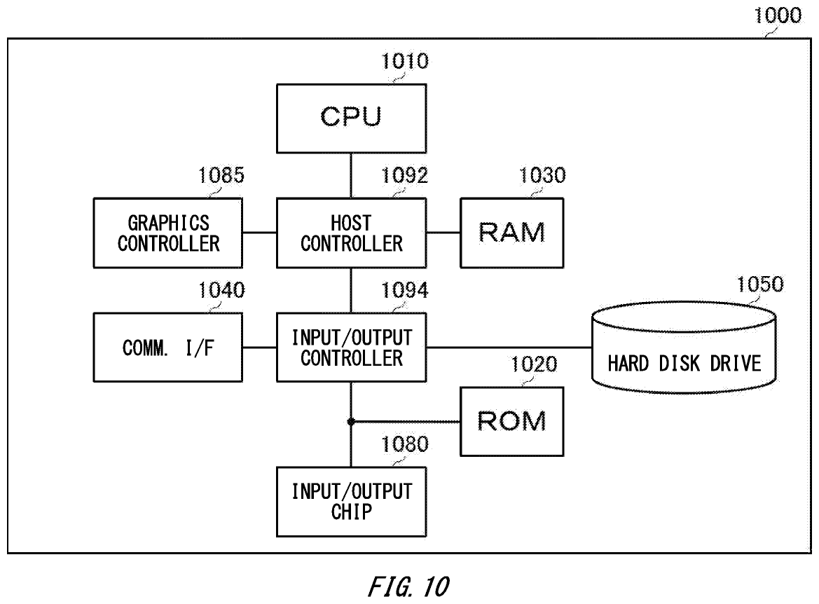

FIG. 10 schematically illustrates an exemplary computer 1000 to function as the control device 200. The computer 1000 according to the present embodiment includes: a CPU peripheral unit having a CPU 1010, a RAM 1030, and a graphics controller 1085 that are interconnected by a host controller 1092; and an input/output unit having a ROM 1020, a communication I/F 1040, a hard disk drive 1050, and an input/output chip 1080 that are connected to the host controller 1092 by an input/output controller 1094.

The CPU 1010 performs operations based on programs stored in the ROM 1020 and RAM 1030, and performs control of a unit(s). The graphics controller 1085 acquires image data generated by the CPU 1010 or the like on a frame buffer provided in the RAM 1030, and makes a display display the image data. Instead, the graphics controller 1085 may include therein a frame buffer to store image data generated by the CPU 1010 or the like.

The communication I/F 1040 communicates with another device via a network through a wired or wireless connection. In addition, the communication I/F 1040 functions as hardware to perform communication. The hard disk drive 1050 stores programs and data to be used by the CPU 1010.

The ROM 1020 stores a boot-program to be executed by the computer 1000 at the time of activation, and programs or the like that depend on hardware of the computer 1000. The input/output chip 1080 connects various types of input/output devices to the input/output controller 1094 via, for example, a parallel port, a serial port, a keyboard port, a mouse port, and the like.

Programs to be provided to the hard disk drive 1050 via the RAM 1030 are provided by a user as programs stored in a recording medium such as an IC card. The programs are read out from the recording medium, installed in the hard disk drive 1050 via the RAM 1030, and executed at the CPU 1010.

The programs that are installed in the computer 1000, and make the computer 1000 function as the control device 200 may act on the CPU 1010 or the like, and may each make the computer 1000 function as a unit(s) of the control device 200. Information processing described in these programs are read in by the computer 1000 to thereby function as the target geographical point indication acquiring unit 202, positional information sending unit 204, image-capturing direction indication receiving unit 206, candidate display control unit 208, selection indication receiving unit 210, request-information sending unit 212, connection establishing unit 214, captured-image receiving unit 216, display control unit 218, device information acquiring unit 220, presence judging unit 222, time estimating unit 224, and time display unit 226, which are specific means attained by cooperation between software and various types of hardware resources mentioned above. Then, with these specific means, operations on or processing of information corresponding to an intended use of the computer 1000 in the present embodiment are realized to thereby construct the unique control device 200 corresponding to the intended use.

Although in the embodiments explained above, the control device 200 is an exemplary control device, this is not the sole example, and for example a communication terminal owned by a user of a vehicle 100 who is in the vehicle 100 may function as a control device.

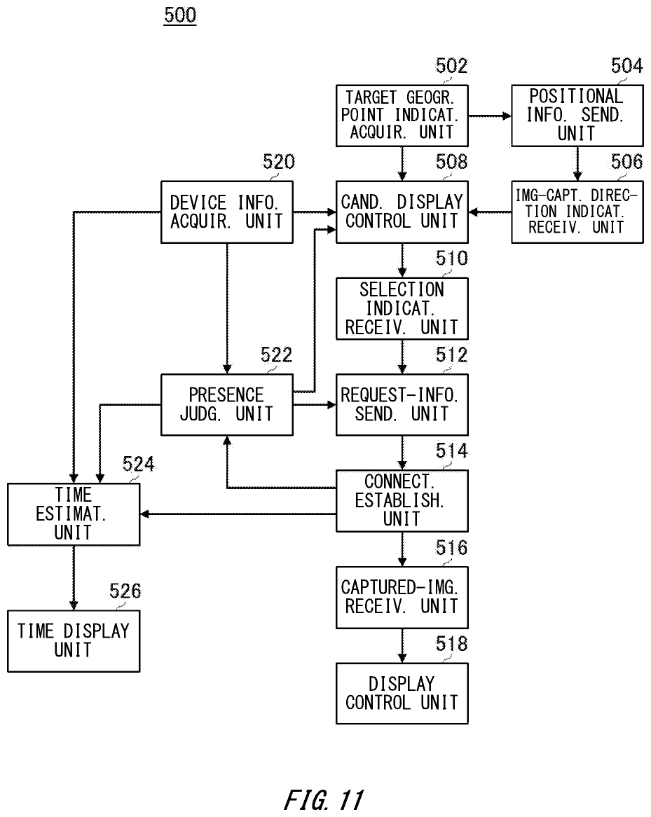

FIG. 11 schematically illustrates an exemplary functional configuration of a communication terminal 500. The communication terminal 500 includes a target geographical point indication acquiring unit 502, a positional information sending unit 504, an image-capturing direction indication receiving unit 506, a candidate display control unit 508, a selection indication receiving unit 510, a request-information sending unit 512, a connection establishing unit 514, a captured-image receiving unit 516, a display control unit 518, a device information acquiring unit 520, a presence judging unit 522, a time estimating unit 524, and a time display unit 526. Here, differences in processing contents from those related to the control device 200 illustrated in FIG. 5 are mainly explained.

The target geographical point indication acquiring unit 502 acquires an indication of an image-capturing target geographical point. The target geographical point indication acquiring unit 502 may acquire an image-capturing target geographical point selected on a map application, for example.

The positional information sending unit 504 broadcasts, to other devices, positional information indicating the image-capturing target geographical point indicated by the indication acquired by the target geographical point indication acquiring unit 502. The positional information sending unit 504 may broadcast, to other devices, positional information via the network 10. In addition, the positional information sending unit 504 may broadcast request information to other devices via a vehicle 100 which a user carrying the communication terminal 500 is in. The positional information sending unit 504 may establish a connection with a vehicle 100 which a user is in through short-range wireless communication such as Bluetooth (registered trademark) communication, for example, and send positional information to the vehicle 100 via the connection. In this manner, communication between each configuration provided to the communication terminal 500 and a component outside the vehicle 100 may be executed via the vehicle 100.

The image-capturing direction indication receiving unit 506 receives an indication of an image-capturing direction. The candidate display control unit 508 causes an image-capturing direction indicated by an indication received by the image-capturing direction indication receiving unit 506 to be displayed as an image-capturing direction candidate. The candidate display control unit 508 may cause a display provided to the communication terminal 500 to display an image-capturing direction candidate. The selection indication receiving unit 510 receives an indication of selection of an image-capturing direction candidate. The selection indication receiving unit 510 may receive, via pointing input, audio input, or the like, an indication of a selection of an image-capturing direction candidate displayed on the display provided to the communication terminal 500 under control of the candidate display control unit 508.

The request-information sending unit 512 sends request information for requesting a device to send a captured image of an image-capturing target geographical point, the device being a device that is to capture an image of the image-capturing target geographical point in the direction of the image-capturing direction candidate indicated by an indication of selection received by the selection indication receiving unit 510. If a positive acknowledgement to the request information sent by the request-information sending unit 512 is received, the connection establishing unit 514 establishes a connection for communication of a captured image with the device that sent the positive acknowledgement. The captured-image receiving unit 516 receives s captured image from the device via the connection established by the connection establishing unit 514.

The device information acquiring unit 520 acquires device information. The device information acquiring unit 520 may receive device information about another device from a vehicle 100 which the user is in. In addition, the device information acquiring unit 520 may receive device information about a plurality of devices via the network 10 from a managing device that manages the device information about the plurality of devices.

Based on device information acquired by the device information acquiring unit 520, the candidate display control unit 508 may identify a direction in which another device can capture an image of an image-capturing target geographical point, and cause the identified direction to be displayed as an image-capturing direction candidate. Before a moving body as a device that has established a connection with the connection establishing unit 514 passes through an image-capturing target geographical point, the presence judging unit 522 judges, based on device information, whether or not there is another device that can capture an image of the image-capturing target geographical point in an image-capturing direction indicated by an indication of selection received by the selection indication receiving unit 510. If the presence judging unit 522 judges that there is such a device, the request-information sending unit 512 may send request information for requesting the device to send a captured image of the image-capturing target geographical point. In addition, if the presence judging unit 522 judges that there is not such a device, the candidate display control unit 508 identifies a direction in which another device can capture an image of the image-capturing target geographical point at the time of the judgement, and causes the identified image-capturing direction to be displayed as an image-capturing direction candidate.

Before a moving body as a device that has established a connection with the connection establishing unit 514 captures an image of an image-capturing target geographical point, the presence judging unit 522 may judge, based on device information, whether or not there is another device that can capture an image of the image-capturing target geographical point in an image-capturing direction indicated by an indication of selection received by the selection indication receiving unit 510. If the presence judging unit 522 judges that there is such a device, the request-information sending unit 512 may send request information for requesting the device to send a captured image of the image-capturing target geographical point.

The time estimating unit 524 estimates a length of time required for a moving body as a device that has established a connection with the connection establishing unit 514 to capture an image of the image-capturing target geographical point. The time display unit 526 causes the length of time estimated by the time estimating unit 524 to be displayed. The time display unit 526 causes a display provided to the communication terminal 500 to display the length of time, for example.

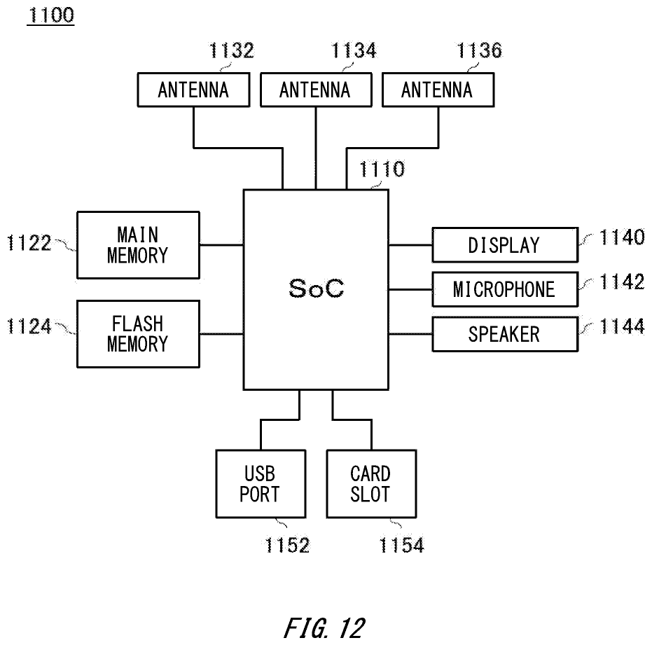

FIG. 12 illustrates an exemplary hardware configuration of a computer 1100 to function as the communication terminal 500. The computer 1100 according to the present embodiment includes an SoC 1110, a main memory 1122, a flash memory 1124, an antenna 1132, an antenna 1134, an antenna 1136, a display 1140, a microphone 1142, a speaker 1144, a USB port 1152, and a card slot 1154.

The SoC 1110 performs operations based on programs stored in the main memory 1122 and flash memory 1124, and performs control of a unit(s). The antenna 1132 is a so-called cellular antenna. The antenna 1134 is a so-called WiFi antenna. The antenna 1136 is a so-called short-range wireless communication antenna such as a Bluetooth antenna. The SoC 1110 may use the antenna 1132, antenna 1134, and antenna 1136 to realize various types of communication functions. The SoC 1110 may use the antenna 1132, antenna 1134, or antenna 1136 to receive a program to be used by the SoC 1110, and store the program in the flash memory 1124.

The SoC 1110 may use the display 1140 to realize various types of display functions. The SoC 1110 may use the microphone 1142 to realize various types of audio input functions. The SoC 1110 may use the speaker 1144 to realize various types of audio output functions.

The USB port 1152 realizes USB connection. The card slot 1154 realizes connection with various types of cards such as SD cards. The SoC 1110 may receive a program to be used by the SoC 1110 from equipment or a memory connected to the USB port 1152, and a card connected to the card slot 1154, and store the program in the flash memory 1124.

The programs that are installed in the computer 1100, and make the computer 1100 function as the communication terminal 500 may act on the SoC 1110 or the like, and may each make the computer 1100 function as a unit(s) of the communication terminal 500. Information processing described in these programs are read in by the computer 1100 to thereby function as the target geographical point indication acquiring unit 502, positional information sending unit 504, image-capturing direction indication receiving unit 506, candidate display control unit 508, selection indication receiving unit 510, request-information sending unit 512, connection establishing unit 514, captured-image receiving unit 516, display control unit 518, device information acquiring unit 520, presence judging unit 522, time estimating unit 524, and time display unit 526, which are specific means attained by cooperation between software and various types of hardware resources mentioned above. Then, with these specific means, operations on or processing of information corresponding to an intended use of the computer 1100 in the present embodiment are realized to thereby construct the unique communication terminal 500 corresponding to the intended use.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCE SYMBOLS

10: network; 100: vehicle; 110: manipulating unit; 120: display unit; 130: wireless communication unit; 140: image capturing unit; 150: GNSS receiving unit; 160: sensor unit; 200: control device; 202: target geographical point indication acquiring unit; 204: positional information sending unit; 206: image-capturing direction indication receiving unit; 208: candidate display control unit; 210: selection indication receiving unit; 212: request-information sending unit; 214: connection establishing unit; 216: captured-image receiving unit; 218: display control unit; 220: device information acquiring unit; 222: presence judging unit; 224: time estimating unit; 226: time display unit; 302: image-capturing target geographical point; 312: candidate; 314: candidate; 320: current position; 410: vehicle; 420: vehicle; 430: vehicle; 500: communication terminal; 502: target geographical point indication acquiring unit; 504: positional information sending unit; 506: image-capturing direction indication receiving unit; 508: candidate display control unit; 510: selection indication receiving unit; 512: request-information sending unit; 514: connection establishing unit; 516: captured-image receiving unit; 518: display control unit; 520: device information acquiring unit; 522: presence judging unit; 524: time estimating unit; 526: time display unit; 1000: computer; 1010: CPU; 1020: ROM; 1030: RAM; 1040: communication I/F; 1050: hard disk drive; 1080: input/output chip; 1085: graphics controller; 1092: host controller; 1094: input/output controller; 1100: computer; 1110: SoC; 1122: main memory; 1124: flash memory; 1132: antenna; 1134: antenna; 1136: antenna; 1140: display; 1142: microphone; 1144: speaker; 1152: USB port; 1154: card slot

What is claimed is:

1. A control device comprising:
a target geographical point indication acquiring unit that acquires an indication of an image-capturing target geographical point;
a candidate display control unit that causes an image-capturing direction candidate to be displayed, the image-capturing direction candidate being a candidate of a direction in which an image of the image-capturing target geographical point is to be captured;
a selection indication receiving unit that receives an indication of selection of an image-capturing direction candidate; and
a captured-image receiving unit that receives, from a device, a captured image capturing an image of the image-capturing target geographical point, the device being a device that has captured the image of the image-capturing target geographical point in a direction of the image-capturing direction candidate indicated by the indication of selection received by the selection indication receiving unit.

2. The control device according to claim 1, comprising:
a positional information sending unit that broadcasts positional information indicating the image-capturing target geographical point; and
an image-capturing direction indication receiving unit that receives, from a device, an indication of an image-capturing direction in which an image of the image-capturing target geographical point has been captured, the device being a device that has received the positional information, and has already captured the image of the image-capturing target geographical point, wherein
the candidate display control unit causes the image-capturing direction indicated by the indication received by the image-capturing direction indication receiving unit to be displayed as the candidate.

3. The control device according to claim 2, wherein, along with the positional information and as a condition for determining whether or not an image of the image-capturing target geographical point has already been captured, the positional information sending unit broadcasts a condition based on which a judgement is made that an image of the image-capturing target geographical point has already been captured if an image of the image-capturing target geographical point has been captured in a time period from a first time point at which the positional information has been received to a second time point which is a predetermined length of time before the first time point.

4. The control device according to claim 1, comprising:
a positional information sending unit that broadcasts positional information indicating the image-capturing target geographical point; and
an image-capturing direction indication receiving unit that receives, from a device, an indication of an image-capturing direction in which an image of the image-capturing target geographical point is to be captured, the device being a device that has received the positional information, and is to capture an image of the image-capturing target geographical point after receiving the positional information, wherein
the candidate display control unit causes the image-capturing direction indicated by the indication received by the image-capturing direction indication receiving unit to be displayed as the candidate.

5. The control device according to claim 4, comprising:
a request-information sending unit that sends request information for requesting a device to send a captured image of the image-capturing target geographical point, the device being a device to capture an image of the image-capturing target geographical point in the direction of the image-capturing direction candidate indicated by the indication of selection received by the selection indication receiving unit; and
a connection establishing unit that establishes a connection with the device if a positive acknowledgement to the request information is received, wherein
the captured-image receiving unit receives the captured image from the device via the connection established by the connection establishing unit.

6. The control device according to claim 1, comprising a device information acquiring unit that acquires device information including a position of a device, wherein
the candidate display control unit identifies, based on the device information, a direction in which the device can capture an image of the image-capturing target geographical point, and causes the identified direction to be displayed as the image-capturing direction candidate.

7. The control device according to claim 6, comprising:
a request-information sending unit that sends request information for requesting a device to send a captured image of the image-capturing target geographical point, the device being a device that can capture an image of the image-capturing target geographical point in the direction of the image-capturing direction candidate indicated by the indication of selection received by the selection indication receiving unit; and
a connection establishing unit that establishes a connection with the device if a positive acknowledgement to the request information is received, wherein
the captured-image receiving unit receives the captured image from the device via the connection established by the connection establishing unit.

8. The control device according to claim 7, comprising a presence judging unit that judges, based on the device information, whether or not there is a second device that can capture an image of the image-capturing target geographical point in the image-capturing direction, the judgement being made before a moving body as the device with which the connection establishing unit has established a connection captures an image of the image-capturing target geographical point, wherein
if the presence judging unit judges that there is a second device that can capture an image of the image-capturing target geographical point in the image-capturing direction, the request-information sending unit sends, to the second device, request information for requesting the second device to send a captured image of the image-capturing target geographical point captured in the image-capturing direction.

9. The control device according to claim 7, comprising a presence judging unit that judges, based on the device information, whether or not there is a second device that can capture an image of the image-capturing target geographical point in the image-capturing direction, the judgement being made before a moving body as the device with which the connection establishing unit has established a connection captures an image of the image-capturing target geographical point, wherein
if the presence judging unit judges that there is not a second device that can capture an image of the image-capturing target geographical point in the image-capturing direction, the candidate display control unit causes the image-capturing direction candidate to be displayed.

10. The control device according to claim 7, comprising:
a time estimating unit that estimates a length of time required for a moving body as the device with which the connection establishing unit has established a connection to capture an image of the image-capturing target geographical point;
a presence judging unit that judges, based on the device information, whether or not there is a second device that can capture an image of the image-capturing target geographical point in the image-capturing direction, the judgement being made before the moving body captures an image of the image-capturing target geographical point; and
a time display unit that causes the length of time to be displayed, if the presence judging unit judges that there is not a second device that can capture an image of the image-capturing target geographical point in the image-capturing direction.

11. The control device according to claim 9, comprising:
a time estimating unit that estimates a length of time required for a moving body as the device with which the connection establishing unit has established a connection to capture an image of the image-capturing target geographical point; and
a time display unit that causes the length of time to be displayed, if the presence judging unit judges that there is not a second device that can capture an image of the image-capturing target geographical point in the image-capturing direction.

12. The control device according to claim 7, comprising a presence judging unit that judges, based on the device information, whether or not there is a second device that can capture an image of the image-capturing target geographical point in the image-capturing direction, the judgement being made before a moving body as the device with which the connection establishing unit has established a connection passes through the image-capturing target geographical point, wherein
if the presence judging unit judges that there is a second device that can capture an image of the image-capturing target geographical point in the image-capturing direction, the request-information sending unit sends, to the second device, request information for requesting the second device to send a captured image of the image-capturing target geographical point captured in the image-capturing direction.

13. The control device according to claim 1, wherein the candidate display control unit causes a direction of a road positioned within a predetermined range from the image-capturing target geographical point to be displayed as an image-capturing direction candidate.

14. The control device according to claim 13, wherein if a road positioned within a predetermined range from the image-capturing target geographical point is a one-way road, the candidate display control unit causes only an advancing direction of the one-way road to be displayed as the image-capturing direction candidate.

15. A non-transitory computer-readable storage medium having stored thereon a program for causing a computer to function as:
a target geographical point indication acquiring unit that acquires an indication of an image-capturing target geographical point;
a candidate display control unit that causes an image-capturing direction candidate to be displayed, the image-capturing direction candidate being a candidate of a direction in which an image of the image-capturing target geographical point is to be captured;
a selection indication receiving unit that receives an indication of selection of an image-capturing direction candidate; and
a captured-image receiving unit that receives, from a device, a captured image capturing an image of the image-capturing target geographical point, the device being a device that has captured the image of the image-capturing target geographical point in a direction of the image-capturing direction candidate indicated by the indication of selection received by the selection indication receiving unit.
